(19) United States
(12) Patent Application Publication
(10) Pub. No.: US 2003/0014969 A1
(43) Pub. Date: Jan. 23, 2003

(54) Turbine apparatus capable of producing power when held stationary in a stream of flowing water

(76) Inventor: Victor Walters, Sechelt (CA)

Correspondence Address: David J. French, Stn. D, Box 2486, Ottawa, K1P 5W6, CA

(21) Appl. No.: 09/909,840

(22) Filed: Jul. 23, 2001

(51) Int. Cl. F03D 11/04; F03B 13/00

(52) U.S. Cl. 60/398; 415/7

(57) ABSTRACT

A barge with a water turbine is anchored in a river. The turbine is immersed in the water between two separated hulls. Water is directed to flow in a concentrated state between the hulls, turning the turbine and generating electricity.

### BACKGROUND OF THE INVENTION

1. Field of the Invention

The present invention relates to turbine apparatus for producing power from water flowing in a river or stream or within a tidal basin.

2. Prior Art

Numerous proposals have previously been made for turbine apparatus which is suited to being located in a flowing stream and capable of producing power from the water flow. In some cases the apparatus is fixed to a river bed and includes axial flow turbines. Other apparatus has been proposed to be made in the form of a floating barge designed to be anchored in a stream. The present invention provides apparatus of the latter type, which is particularly economical in construction and effective in use.

### SUMMARY OF THE INVENTION

According to one aspect of the present invention, turbine apparatus capable of producing power when held stationary in a stream of flowing water comprises:

a floatable body having two spaced, parallel, hollow side members joined by several spaced cross members, said side and cross members being arranged so that said side members provide a flow passage for water therebetween from an upstream end of said body to a downstream end thereof while the cross members are largely above the level of water in which the body floats;

at least one rotor having blades and rotatable on a horizontal shaft, the shaft having opposite end portions mounted in bearings each held by one of the side members so that the shaft is normally above the water level and so that the blades extend down into the water in the flow passage and are transverse to the direction of water flow in the passage; and

power producing means rotatably connected to the rotor.

In a preferred form of the invention, the upstream ends of the side members have deflecting surfaces configured to direct the flowing water laterally into the flow channel to enhance the energy of water flowing through the channel.

Preferably, two of the rotors are provided, one being adjacent to the upstream end of the body and one being adjacent to its downstream end, and the cross members are all positioned between the two rotors.

The hollow side members may both be in the form of tubes, so that the floatable body is in effect a pontoon barge. Preferably, the deflecting surfaces are provided by end faces of these tubes, each end face extending across the full width of the respective side member and being sloped at angle of less than 50° to a longitudinal axis of the tube in such direction as to direct flowing water into the channel.

Buoyancy of the apparatus is enhanced by the use of buoyant rotors. Preferably, each rotor includes both a hollow watertight cylinder which is buoyant, and the blades which are attached to the surface of the rotor are also hollow and watertight.

A further optional feature of the invention is a wind turbine supported by the cross-members. Such turbine is preferably positioned between two rotors where the rotors are adjacent opposite ends of the floating body.

### BRIEF DESCRIPTION OF THE DRAWINGS

A preferred embodiment of the invention will now be described by way of example with reference to the accompanying drawings, in which;

FIG. 1 shows a partly sectioned side view of the turbine apparatus floating in water;

FIG. 2 is a partly sectioned plan view of the apparatus, and also showing water flow through and past the apparatus; and

FIG. 3 is a sectional view on lines 3-3 of FIG. 2.

### DETAILED DESCRIPTION

The drawings show the turbine apparatus floating in a body of water having a water surface or waterline W; the manner in which the water flows being indicated by arrows. The body of water may be a river or tidal water.

The apparatus comprises a floatable body 10 comprising two spaced, parallel, hollow side members 12 each in the form of a watertight cylindrical tube, preferably of metal such as steel. At each end of the tubes an inwardly facing sloping end face 14 is provided so that at the upstream end of the body the flowing water is diverted, relatively smoothly, into a flow channel between the side members, and so that it leaves the channel at the downstream end and merges smoothly with the main stream of water. Specifically, each end face 14 extends across the full width of the respective side member 12 and lies in a vertical plane which is at an angle of less than about 50° to the longitudinal axis of the member, preferably at about 45° to this axis.

The two side members 12 have their central portions joined by a series of six parallel cross members 16 having their ends welded to the members 12 to make the floatable body a rigid structure. Each of these cross members 16 is in the form of a hollow cylindrical steel tube of lesser diameter than that the side member tubes 12, preferably about 50% of the diameter of tubes 12. The cross members 16 are arranged with their axes above those of the side members 12 so that the main parts of these members are above the centerlines of members 12 and are also largely above the waterline W so as not to restrict flow in the flow passage.

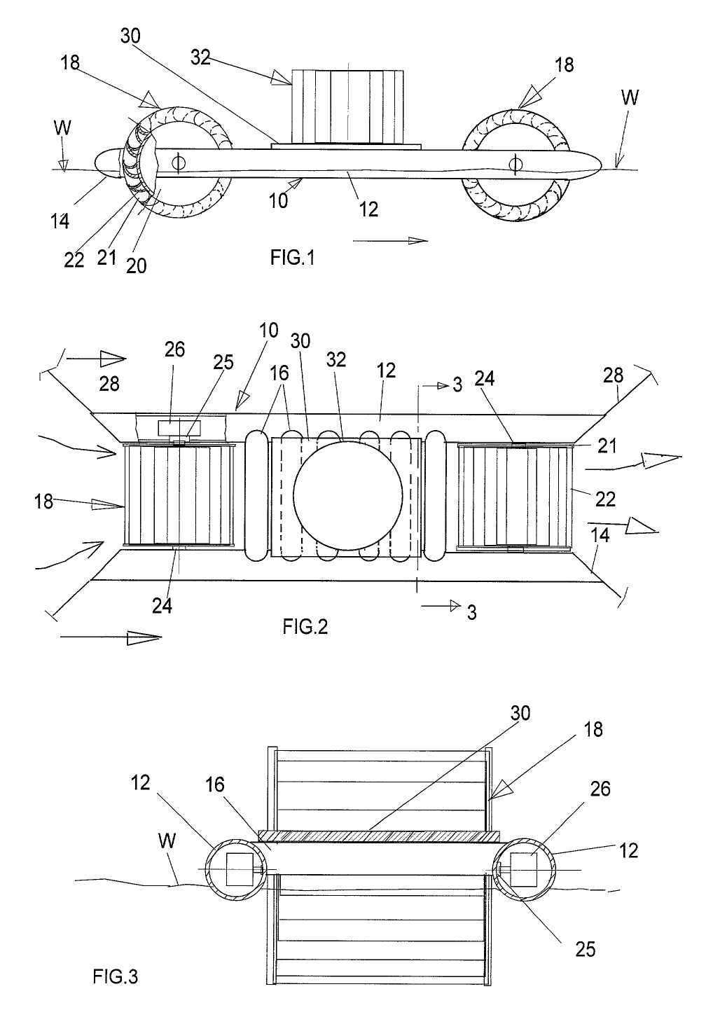

Upstream and downstream end portions of the floatable body 10, outside of a central area having the cross members 16, are each provided with a turbine rotor 18. Each rotor comprises a hollow, watertight and buoyant cylinder 20 having two end plates 21 which support between them a series of blades 22 projecting from the surface of the cylinder and which extend parallel to the rotor axis. These blades 22 are also hollow, watertight and buoyant, having their ends closed by the end plates 21 which also close the ends of the cylinder 20. In cross section, as in the left-hand side of FIG. 1, blades 22 have the form of curved triangles where upstream and downstream sides of the triangles are respectively concave and convex. Each rotor is supported by a horizontal shaft 24 which is held by bearings 25 recessed within adjacent sides of the side members 12, one of which is shown in the left-hand side of FIG. 2. The arrangement is such that the shaft 24, which is at a level close to the vertical centers of the side members 12, is normally above water level and such that the blades 22 extend down into the water in the flow passage and are transverse to the direction of water flow in the passage. At least one end of each shaft 24 is rotatably connected to an electrical generator 26 which is also mounted within the tubular side member 12. The bearings 25 are watertight so that water does not enter the side members where these are penetrated by the shafts 24. Preferably, large size bearings are used which have lifetime watertightness and lifetime lubrication. The side members 12 are of sufficiently large diameter to provide adequate space for servicing the generators.

Suitable dimensions for the body 10 are a length of 288 feet and a width of 120 feet. The turbine rotor may be 80 feet in length and 80 feet in diameter. Side members 12 may be 20 feet in diameter.

In use, the floatable body 10 is anchored in a flowing stream by lines 28 at each corner so that the water flows along the flow passage between the side members 12, the flow rate and energy being enhanced by the angled ends of the side members which divert water into the passage. An economical structure is achieved by having all the main parts buoyant including the rotors and even the rotor blades 22.

The cross members 16 in the central area of the floatable body 10 optionally support a platform 30 which in turn carries one or more vertical axis wind generators 32. Such generators are preferably constructed in accordance with my prior U.S. Pat. No. 5,664,418, which issued Sep. 9, 1997.

Another option is to provide a construction suitable for tidal waters having a fore-and-aft symmetrical arrangement with the rotors oppositely arranged, i.e. having oppositely facing blades, so that one rotor faces the incoming tide, and is caused to rotate and produce energy as the tide comes in, and the other faces and is rotated by the outgoing tide. Wave energy could also be harnessed by having the apparatus located close to shore so that the rotors could capture the forward curling motion of waves as they speed up at the surface and slow down in their lower portions by the action of a beach.

I claim:

1. Turbine apparatus capable of producing power when held stationary in a stream of flowing water, comprising:
a floatable body having two spaced, parallel, hollow side members joined by several spaced cross members, said side and cross members being arranged so that said side members provide a flow passage for water therebetween from an upstream end of said body to a downstream end thereof while the cross members are largely above the level of water in which said body floats;
at least one rotor having blades and being rotatable on a horizontal shaft, said shaft having opposite end portions mounted in bearings each held by one of said side members so that the shaft is normally above the said water level and so that said blades extend down into the water in the flow passage and are transverse to the direction of water flow in said passage; and
power producing means rotatably connected to said rotor;
and wherein upstream ends of said side members have deflecting surfaces configured to direct the flowing water laterally into said flow channel to enhance the energy of water flowing through said channel.

2. Turbine apparatus according to claim 1, wherein two of said rotors are provided, one being adjacent to the upstream end of the body and one being adjacent to the said downstream end, and said cross members are all positioned between the said rotors.

3. Turbine apparatus according to claim 1, wherein said hollow side members are both in the form of tubes, and wherein said deflecting surfaces are provided by end faces of said tubes, each end face extending across the full width of the respective side member and being sloped at angle of less than 50° to a longitudinal axis of the tube in such direction as to direct flowing water into said channel.

4. Turbine apparatus according to claim 1, wherein said hollow side members are both in the form of tubes, and wherein said power producing means are electrical generators located in one or both of said tubes.

5. Turbine apparatus according to claim 1, wherein each said rotor includes a hollow, watertight cylinder which is buoyant.

6. Turbine apparatus according to claim 5, wherein said blades of the rotor are also hollow and watertight.

7. Turbine apparatus according to claim 2, wherein said rotors are provided in a fore-and-aft symmetrical arrangement, and are oppositely arranged so that water flowing from a first end of said flow passage to the second end rotates a first of the rotors, and water flowing from the second end to the first end of said passage rotates a second of said rotors.

8. Turbine apparatus according to claim 1, further comprising a wind turbine supported by said cross-members.

9. Turbine apparatus for obtaining power when held stationary in a stream of flowing water, comprising:
a floatable body having two spaced, parallel, hollow side members joined by several spaced cross members, said side and cross members being arranged so that said side members provide a flow passage for water therebetween from an upstream end of said body to a downstream end thereof while the cross members are largely above the level of water in which said body floats;
at least one rotor having blades and rotatable on a horizontal shaft, said shaft having opposite end portions mounted in bearings each held by one of said side members so that the shaft is normally above the said water level and so that said blades extend down into the water in the flow passage and are transverse to the direction of water flow in said passage;
power producing means rotatably connected to said rotor; and
a wind turbine supported by said cross-members.

9. Apparatus according to claim 8, wherein two of said rotors are provided, one being adjacent to the upstream end of the body and one being adjacent to the said downstream end, said cross members being all positioned between the said rotors, and wherein said wind turbine is supported by said cross members and is located between said rotors.
